(19) United States
(12) Patent Application Publication
(10) Pub. No.: US 2011/0279656 A1
(43) Pub. Date: Nov. 17, 2011

(54) Surface Scanning System

(75) Inventors: Cem Unsalan, Instanbul (TR); Rifat Benveniste, Istanbul (TR)

(73) Assignee: Yeditepe Universitesi, Istanbul (TR)

(21) Appl. No.: 13/145,337

(22) PCT Filed: May 21, 2009
(86) PCT No.: PCT/IB2009/052130

§ 371 Date: Jul. 19, 2011

(51) Int. Cl. H04N 13/02

(52) U.S. Cl. 348/50; 348/E13.074

(57) ABSTRACT

The present invention relates to a surface scanning system, which enables obtaining three dimensional models of the geometries of the objects particularly having shiny or specular surfaces, and which comprises at least one light source, a moving mechanism that enables the light source to move relative to the object to be scanned, at least one camera, a moving mechanism that enables the camera to move relative to the object to be scanned, a moving mechanism that enables the object to be scanned to move in order for it to be viewed from different angles, at least one controller that controls the light source, camera and the moving mechanisms.

### FIELD OF THE INVENTION

The present invention relates to a surface scanning system which enables obtaining three dimensional models of the geometries of the objects particularly having shiny or specular surfaces.

### BACKGROUND OF THE INVENTION

3D scanners are devices used to extract the surface coordinates of a three dimensional object. These devices are used in various areas such as reverse engineering, computer graphics applications, archeological finding scanning and medical imaging.

There are various methods used to construct 3D scanners. Two main categories of 3D scanners are 1-) non-contact and 2-) contact. 3D scanners based on touch sensors are considered as contact scanners. These devices are not of general use since they are slow and some objects can not be touched either due to their characteristic properties or due to their positions. The 3D scanners in the non-contact category are divided into two main categories: 1-) triangulation based structured light and 2-) other optical property based. Triangulation based structured light 3D scanners take different methods as basis: laser based, projection based and patterned structured light based. Patterned structured light based scanners use different pattern coding strategies such as color and line coding.

In triangulation based structured light 3D scanners, white or colored stripes are projected on the object from a monochromatic or multi spectral light source. These stripes are then reflected and the image of the object onto which a stripe is projected is captured by one or more cameras. From the image captured, bending of the stripe on the object according to the shape of the object is determined and the shape information is obtained by means of triangulation. If the stripe is moved along the object surface, three dimensional model of the object can be obtained.

In patterned structured light scanners, a plurality of stripes is projected on the object at the same time. For this reason, there are problems of stripe correspondence in this type of scanners. In laser or projection stripe based systems, only one stripe is projected on the object; therefore the above mentioned correspondence problem is not experienced in this type of scanners.

Impacts of the surface properties and the lighting conditions of the medium on the quality of the image to be acquired impose a problem for the structured light 3D scanners. As a result of these problems, the scanner can not be used in certain media. For example, problems are encountered when the scanner is used in objects with shiny or specular surfaces. In addition to the light stripes projected on the object, other light rays coming from the outer environment cause noise on the images due to specularity of the object. Although some filtering techniques are used to solve this problem, the said techniques do not eliminate the problem entirely. In the applications carried out, most of the shiny surfaced objects are covered with an opaque material such as powder to suppress the specularity of the surface. There are two major problems with this solution. First of all, covering the entire surface with powder slows down the scanning process. Secondly and lastly, objects such as archeological findings or those that can be affected from powders can not be covered by the said powder-like opaque materials.

The United States patent document US20050116952, known in the art, discloses producing structured-light pattern, wherein high-resolution real-time three-dimensional coordinates can be obtained by using single frame or double frame imaging methods.

In the above mentioned United States patent document, the system used has become complex due to the fact that double frame imaging methods are used. In the method provided in the said document, changing stripe color is projected on the object. Additionally, in the method disclosed in the said document, after the projector which is used as the light source is turned off, an additional image is used. This causes prolongation of the scanning process.

The Great Britain patent document GB2078944 discloses measurement of the surface profile by scanning method upon projection of a color band comprising at least two wavelength bands onto the surface by means of an optic transmitter.

In order for the system disclosed in the above mentioned Great Britain patent document to function, there is a need of one visible and one invisible wavelength for the light sources. This renders the system complicated due to the fact that the system needs a reflector and a sensor of two different structures.

### SUMMARY OF THE INVENTION

The objective of the present invention is to provide a surface scanning system which enables performing three dimensional modeling of objects with shiny or specular surfaces without having any difficulty.

### DETAILED DESCRIPTION OF THE INVENTION

The surface scanning system developed to fulfill the objectives of the present invention is illustrated in the accompanying figures, in which,

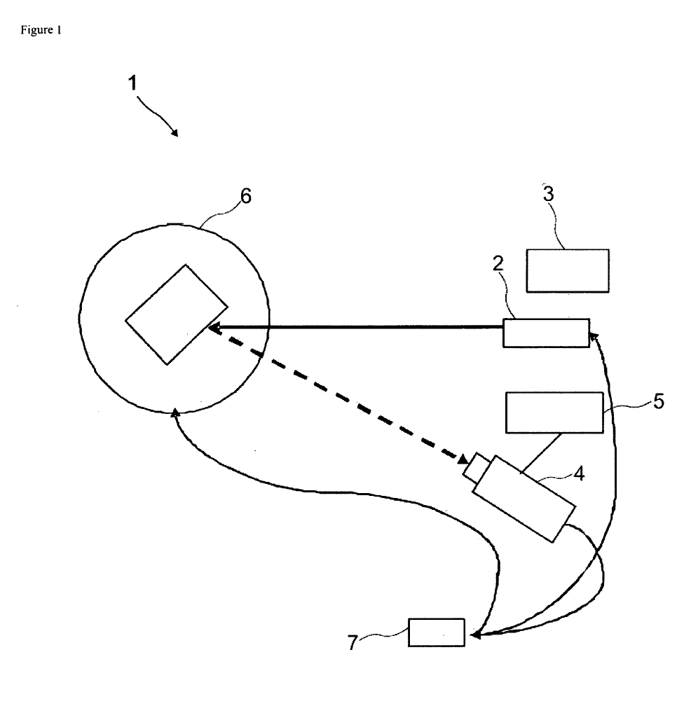

FIG. 1 is the schematic view of a three dimensional surface scanning system.

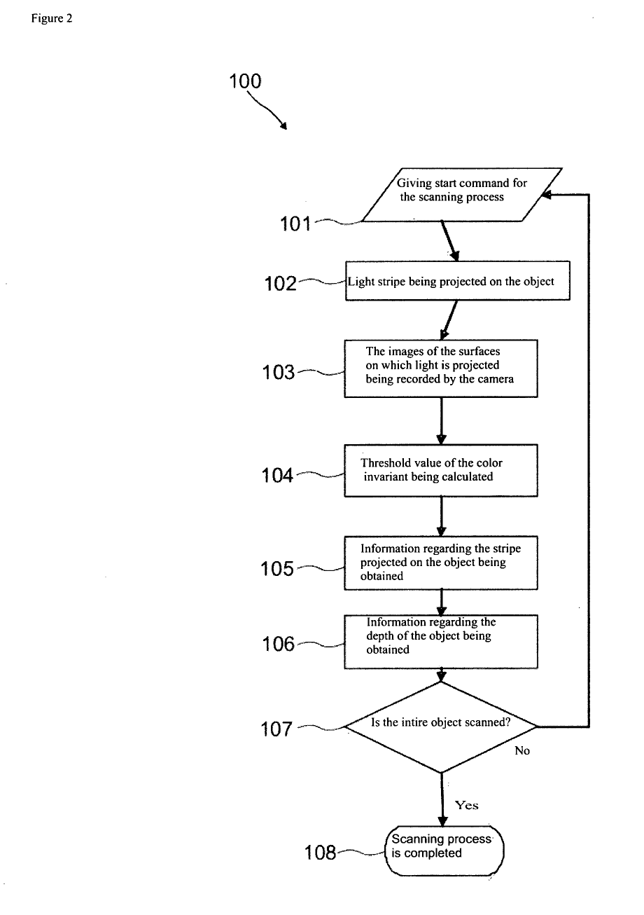

FIG. 2 is the flowchart of the surface scanning process in the three dimensional surface scanning system.

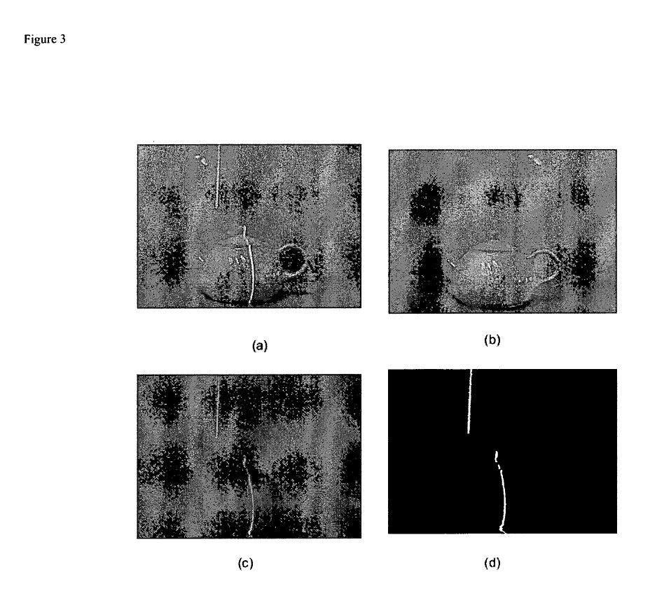

FIG. 3 is the drawings which show the stripe taking the shape of the object on which it is projected in three dimensional surface scanning system.

The surface scanning system (1) comprises at least one light source (2), a moving mechanism (3) which enables the light source (2) to move relative to the object to be scanned, at least one camera (4), a moving mechanism (5) which enables the camera (4) to move relative to the object to be scanned, a moving mechanism (6) which enables the object to be scanned to move in order for it to be viewed from different angles, at least one controller (7) which controls the light source (2), camera (4) and the moving mechanisms (3, 5, 6).

The moving mechanisms (3, 5, 6) provided in the inventive surface scanning system (1) move in all directions and can turn to any direction.

The camera (4) used in the inventive surface scanning system (1) is preferably a color camera.

In the inventive surface scanning system (1), surface scanning process (100) begins with the start command given to the controller (7) (101). The controller (7) activates the light source (2) that is used and a light stripe is projected from the light source (2) onto the object which will be surface scanned (102). Images of the surfaces on which light is projected are recorded by the camera (4) (103). Then the color invariant, which will distinguish the color of the light source from the image received from the camera, will be found and the color invariant will be applied to the image received from the camera, and the threshold value of the color invariant applied image will be calculated according to the pixel density distribution (histogram) thereof (104). The image to which the color invariants are applied is thresholded according to the threshold value calculated in step 104 and the information regarding the stripe projected from the light source on the object is obtained (105). The bended stripe acquired on the object is processed by triangulation method whereby information regarding the depth on the object is obtained (106). It is checked whether the entire object is scanned or not (107). If the entire object is scanned, the scanning process is finalized (108). If after step 107 the entire object is not scanned, scanning process restarts from step 101.

When light is projected on any object, depending on the surface properties of the object, a certain amount of light is absorbed and a certain amount of light is reflected back in different angles. Here, we can define the light reflected on an object with its two basic properties, namely luminosity and chromaticity. Luminosity on the object varies depending on the luminosity intensity of each source in the medium. Chromaticity varies only depending on the light source that provides that color and the color of the object. For this reason, parameters which are not influenced by the changes depending on the luminosity in the image of the object but returns data depending only on chromaticity are called color invariants. Image of an object is comprised of three main color channels (Red, Green and Blue). Chromaticity in these channels differs from luminosity with various transformations. Each method distinguishing chromaticity is considered as color invariant.

Different types of examples can be given for color invariants: Where R is the red color value and G is the green color value coming from each pixel of the camera sensor, the following equation is a color invariant that may be used in distinguishing the red color.

$$φ = \frac{R - G}{R + G} .$$

A similar color invariant is obtained by YCbCr color transformation. Here Y is the light intensity value independent of the color in the image. In connection with this, Cr can also be used as a color invariant in distinguishing red color. Cr is obtained as follows.

$${C}_{R} = 128 + 112 ( \frac{0.5}{1 - 0.299} ( R - Y ) )$$

There are different sensing cells on the sensor of a color camera which are sensitive to the intensity of each color channel (Red, Green and Blue). In single sensor cameras, these pixels are arranged according to a certain rule. In cameras with a plurality of sensors, the light is first passed through a prism and measured by sensors which are sensitive to different color channels (e.g. 3 CCD cameras). Therefore, the intensity of the red color and the intensity of green color in a light projected on a point are measured by a sensor sensitive to red and a sensor sensitive to green, respectively (the same applies for blue). These measurements are expressed by the sensor with a voltage level. If this voltage level is transferred to the digital medium, the pixel values for all three main colors showing the color intensity are obtained. In a system which is digitalized by being sampled with 8 bits, an intensity value in the range of 0-255 is obtained for each pixel.

### Example

For pure red→red: 255 green: 0 blue: 0
For pure yellow→red: 255 green: 255 blue: 0
For light purple→red: 120 green: 50 blue: 140

In the inventive surface scanning system (1), the threshold value is derived from the image obtained according to the color invariants. In order to calculate the threshold value, upon arranging the number of each color invariant image pixel in the chart, a color invariant intensity distribution (histogram) is attained. Since this distribution is subject to change in a different image, a certain percentage of the distribution is selected as the threshold for each image in the inventive system. The said percentage is preferably above 90%. This way the system can perform adaptive thresholding.

In the inventive surface scanning system (1), the light stripe projected on the object is provided by a projector or a laser whose position is changed by the controller (7). The light emitted by the said laser or projector can be of any color.

The calculated threshold value only comprises the beam projected on the object by the light source. Since color invariants are used in calculating the threshold value, the received image is not affected by the reflection luminance dependant on the other light sources in the medium. The color information in the image received by using color invariants becomes dominant relative to luminosity. Thresholding is performed in connection with this. The color of the light stripe reflected on the object is known by the nature of the system (1). Locations which are thresholded with a color equivalent to the color of the stripe reflected as a result of thresholding bear stripe information. This way noise and shiny parts originating from the lighting conditions are not present in the threshold image.

The light stripe projected on the object in step 105 during scanning, bends on the object depending on the shape of the object. Depth information is obtained by processing the said bends. This process is carried out by applying triangulation method which enables to find the distance of the point to the image plane by means of trigonometric identities.

In FIG. 3 there are provided pictures showing the bending of the light stripe upon taking the shape of the object on which it is projected. Among these pictures, (a) corresponds to the red color band in the color image and (b) corresponds to the green color band in the color image. In all of the pictures, light colors mean high values. In addition to the laser line on the teapot, the effect of the light coming from the external environment is also visible. (c) is the image obtained by a color invariant. (d) is the points which are obtained as a result of thresholding the color invariant and which only comprises the reflected laser line information (here the white points correspond to the laser line). If the normal light intensity were to be thresholded (as most of the other depth scanners do) rather than the color invariant, then other light effects coming from the external environment on the teapot would be obtained. As these points are redundant, they would arise as noise in the step of finding depth.

The reflected laser line would be straight if there would not be any object. But it bended when it was projected on the object. Thus it acquired the shape of the object. This way, three dimensional coordinates of the points on the line can be found by the triangulation method.

In the inventive surface scanning system (1), color invariants are used to obtain the shape and depth information regarding the object to be scanned. Scanning process starts with the start command given to the controller, and the process is performed automatically. The depth information of the object is obtained by the linear movement of the light beam(s) projected on the object.

Most of the scanners in the state of the art are operated in dark environments in order for the scanning process not to be affected by the lighting conditions of the environment. In the inventive method, color invariants are used whereby surface of the object is scanned under any lighting condition and the scanning process is not affected by the ambient light.

It is possible to develop a wide variety of embodiments of the inventive surface scanning system. The invention can not be limited to the examples described herein; it is essentially according to the claims.

1.-7. (canceled)

8. A surface scanning method comprising the steps of:
giving a start command to a controller (101);
the controller activating a light source that is used, and a light stripe being projected from the light source onto an object which will be surface scanned (102);
recording by a camera one or more images of a plurality of surfaces on which light is projected (103); and characterized by the steps of:
determining a color invariant, which will distinguish the color of the light source from the image received from the camera, and the color invariant being applied to the image received from the camera, and a threshold value of the color invariant applied image being calculated according to a pixel density distribution (histogram) thereof (104);
the image to which the color invariants are applied being thresholded according to the threshold value calculated in step 104 whereby the information regarding the stripe projected from the light source on the object being obtained (105);
information regarding a depth of the object being obtained upon processing the distortions on the stripes (106);
checking whether the entire object is scanned or not (107);
finalizing the scanning process if the entire object is scanned (108).

9. A surface scanning method according to claim 8, characterized in that in step 104, upon arranging a number of each color invariant image pixel in a chart, attaining a color invariant intensity distribution (histogram).

10. A surface scanning method according to claim 8, characterized in that information regarding the depth of the object is obtained upon processing the distortions on the stripes by means of a triangulation method in step 106.

11. A surface scanning method according to claim 9, characterized in that information regarding the depth of the object is obtained upon processing the distortions on the stripes by means of a triangulation method in step 106.

12. A surface scanning method according to claim 8, characterized in that a color invariant depending on the color of the stripe projected on the object is found and the said invariant is applied to the image received from the camera.

13. A surface scanning method according to claim 9, characterized in that a color invariant depending on the color of the stripe projected on the object is found and the said invariant is applied to the image received from the camera.

14. A surface scanning method according to claim 10, characterized in that a color invariant depending on the color of the stripe projected on the object is found and the said invariant is applied to the image received from the camera.

15. A surface scanning method according to claim 11, characterized in that a color invariant depending on the color of the stripe projected on the object is found and the said invariant is applied to the image received from the camera.

16. A surface scanning method according to claim 8, characterized in that a predetermined value of the color invariant intensity distribution (histogram) is selected as the threshold for each image.

17. A surface scanning method according to claim 9, characterized in that a predetermined value of the color invariant intensity distribution (histogram) is selected as the threshold for each image.

18. A surface scanning method according to claim 10, characterized in that a predetermined value of the color invariant intensity distribution (histogram) is selected as the threshold for each image.

19. A surface scanning method according to claim 12, characterized in that a predetermined value of the color invariant intensity distribution (histogram) is selected as the threshold for each image.

20. A surface scanning method according to claim 16, characterized in that in order for the color invariant intensity distribution percentage to be selected as the threshold value, the percentage is above 90%.

21. A surface scanning method according to claim 17, characterized in that in order for the color invariant intensity distribution percentage to be selected as the threshold value, the percentage is above 90%.

22. A surface scanning method according to claim 18, characterized in that in order for the color invariant intensity distribution percentage to be selected as the threshold value, the percentage is above 90%.

23. A surface scanning method according to claim 19, characterized in that in order for the color invariant intensity distribution percentage to be selected as the threshold value, the percentage is above 90%.

24. A surface scanning system operating in accordance with the surface scanning method according to claim 8, and characterized by
at least one light source,
a first moving mechanism which enables the light source to move relative to the object to be scanned,
at least one camera,
a second moving mechanism which enables the camera to move relative to the object to be scanned,
a third moving mechanism which enables the object to be scanned to move in order for the object to be viewed from different angles, and
at least one controller which controls the light source, the camera and the first, second and third moving mechanisms.
